(19) United States
(12) Patent Application Publication
(10) Pub. No.: US 2021/0012735 A1
(43) Pub. Date: Jan. 14, 2021

(54) DISPLAY DEVICE AND DISPLAY DEVICE DRIVING METHOD

(71) Applicant: HKC CORPORATION LIMITED, Shenzhen (CN)

(72) Inventor: Jidong YANG, Chongqing (CN)

(21) Appl. No.: 17/041,408

(22) PCT Filed: Nov. 21, 2018
(86) PCT No.: PCT/CN2018/116614

§ 371 Date: Sep. 24, 2020

(30) Foreign Application Priority Data
Nov. 14, 2018 (CN) 201811350578.4

(51) Int. Cl. G09G 3/36; G02F 1/1343; G02F 1/133

(52) U.S. Cl. CPC G09G 3/3614; G09G 3/3688; G09G 3/3607; G02F 1/134363; G02F 1/13306; G02F 2201/123; G09G 2310/027; G09G 2310/0243; G09G 2310/0202; G02F 2201/121; G09G 2300/0426

(57) ABSTRACT

The present application discloses a display device and a display device driving method. The display device includes a display panel; and the display panel includes a plurality of odd column pixel electrodes and a plurality of even column pixel electrodes; the first common electrodes and the odd column pixel electrodes cooperate to drive to form odd column pixels, and the second common electrodes and the even column pixel electrodes cooperate to drive to form even column pixels; and the first common electrodes and the second common electrodes are respectively connected to different electrical signals.

The present application claims the priority to the Chinese Patent Application No. CN201811350578.4, filed with the National Intellectual Property Administration, PRC on Nov. 14, 2018, and entitled “DISPLAY DEVICE AND DISPLAY DEVICE DRIVING METHOD”, which is incorporated herein by reference in its entirety.

### TECHNICAL FIELD

The present application relates to the field of display, and particularly, to a display device and a display device driving method.

### BACKGROUND

The description herein merely provides background information related to the present application and does not necessarily constitute prior art.

With the development and advancement of science and technology, liquid crystal displays (LCD) are widely applied due to its advantages in thin body, low power consumption, no radiation, and on the like. Most LCDs as known by the inventor are backlight-type LCDs, each including a liquid crystal panel and a backlight module. The working principle of the liquid crystal panel is to place liquid crystal molecules between two parallel glass substrates, and then apply drive voltage on the two glass substrates to control the rotation direction of the liquid crystal molecules, so that light of the backlight module can be refracted to produce an image.

Common electrode of the display panel is of a one-piece thin film transistor (TFT) material, thus, the polarity of the entire common electrode may change if changes take place in polarity of the Vcom, and only frame inversion and row inversion can be realized. In addition, since load of the common electrode is large, the change in polarity of the Vcom will have a certain delay, and thereby the Vcom cannot be applied to the LCD panel.

### SUMMARY

An object of the present application is to provide a display device and a display device driving method, to reduce load and better display images of the display panel.

The present application provides a display device, including:

a display panel;

the display panel, including:

a plurality of odd column pixel electrodes and a plurality of even column pixel electrodes; and

first common electrodes and second common electrodes;

where the first common electrodes and the odd column pixel electrodes cooperate to drive to form odd column pixels; and the second common electrodes and the even column pixel electrodes cooperate to drive to form even column pixels; and

the first common electrodes and the second common electrodes are respectively connected to different electrical signals.

Optionally, the display device includes a drive voltage driving the display panel, the drive voltage, including:

a common electrode signal generating circuit outputting first common electrode signals and second common electrode signals, the first common electrode signals being transmitted to the first common electrodes, and the second common electrode signals being transmitted to the second common electrodes; and

a data driver chip generating a plurality of grayscale signals, each being respectively connected to one corresponding signal of the odd column pixels and even column pixels, where the data driver chip controls the grayscale signals of the odd column pixels and those of the even column pixels to have different polarities;

where the first common electrode signals and the second common electrode signals have different polarities; the polarities of the first common electrode signals are opposite to the polarities of the grayscale signals of the odd column pixels; and the polarities of the second common electrode signals are opposite to the polarities of the grayscale signals of the even column pixels.

Optionally, the grayscale signals of the pixel electrodes perform polarity inversion in units of frames, and the first common electrode signals and the second common electrode signals perform polarity inversion corresponding to the grayscale signals of the pixel electrodes.

Optionally, the display panel further includes a first common line and a second common line, where the first common line is electrically connected to the first common electrodes, and the second common line is electrically connected to the second common electrodes; the first common electrodes and the current odd column pixel electrodes form a pixel capacitor of current odd column pixels; and the first common line and the current odd column pixel electrodes form a storage capacitor of current odd column pixel electrodes.

Accordingly, the second common electrodes and the current even column pixel electrodes form a pixel capacitor of current even column pixels; and the second common line and the current even column pixel electrodes form a storage capacitor of current even column pixels.

Optionally, during a same frame of time:

the data driver chip controls grayscale signals of pixels in a same column to have a same polarity;

the first common electrode signals have a same polarity;

the second common electrode signals have a same polarity;

during a next frame of time, the grayscale signals, the first common electrode signals, and the second common electrode signals perform polarity inversion.

Optionally, during a frame of time when a row of scanning lines is turned on:

the data driver chip controls grayscale signals of pixels in a same column to have a same polarity;

the first common electrode signals have a same polarity;

the second common electrode signals have a same polarity;

during the time when a row of scanning lines is turned on, the grayscale signals, the first common electrode signals, and the second common electrode signals perform polarity inversion.

Optionally, the display panel includes:

a first substrate and a second substrate that are disposed opposite to each other;

the plurality of odd column pixels and the plurality of even column pixels are all disposed on the first substrate;

the first common electrodes and the second common electrodes are both disposed on the second substrate;

where the first substrate further includes a first common line and a second common line,

the first common line is electrically connected to the first common electrodes, and the second common line is electrically connected to the second common electrodes; the first common electrodes and the current odd column pixel electrodes form a pixel capacitor of current odd column pixels; and the first common line and the current odd column pixel electrodes form a storage capacitor of the current odd column pixel electrodes; and

Accordingly, the second common electrodes and the current even column pixel electrodes form a pixel capacitor of current even column pixels; and the second common line and the current even column pixel electrodes form a storage capacitor of current even column pixel electrodes.

The present application further discloses a display device, including:

a display panel;

a drive voltage driving the display panel;

the display panel includes a first substrate and a second substrate that are disposed opposite to each other;

the first substrate includes a plurality of odd column pixels and a plurality of even column pixels;

the second substrate includes first common electrodes and second common electrodes, where the first common electrodes are disposed opposite to the odd column pixels on the first substrate, and the second common electrodes are disposed opposite to the even column pixels on the first substrate;

the drive voltage includes:

a common electrode signal generating circuit outputting first common electrode signals and second common electrode signals, the first common electrode signals being output to the first common electrodes on the second substrate, and the second common electrode signals being output to the second common electrodes on the second substrate; and

a data driver chip generating a plurality of grayscale signals, each being respectively connected to one corresponding signal of the odd column pixels and even column pixels on the first substrate, where the data driver chip controls the grayscale signals of the odd column pixels and even column pixels on the first substrate to have different polarities;

where the first common electrode signals and the second common electrode signals have different polarities; the polarities of the first common electrode signals are opposite to the polarities of the grayscale signals of the odd column pixels; and the polarities of the second common electrode signals are opposite to the polarities of the grayscale signals of the even column pixels.

The present application further discloses a display device driving method, and the odd column pixel electrodes and even column pixel electrodes are driven by voltages having different polarities;

where the polarities of the first common electrode signals are opposite to the polarities of the grayscale signals of the odd column pixels; and the polarities of the second common electrode signals are opposite to the polarities of the grayscale signals of the even column pixels.

Optionally, during a same frame of time:

the data driver chip controls grayscale signals of pixels in a same column to have a same polarity;

the first common electrode signals have a same polarity;

the second common electrode signals have a same polarity;

during a next frame of time, the grayscale signals, the first common electrode signals, and the second common electrode signals perform polarity inversion.

Compared with a solution where a common electrode is a one-piece indium thin oxide (ITO), the polarity of the entire common electrode may change if changes take place in polarity of the Vcom, and only frame inversion and row inversion can be realized, the display panel of the present application includes a plurality of odd column pixel electrodes and a plurality of even column pixel electrodes, where the odd column pixel electrodes and the first common electrodes cooperate to form odd column pixels, and the second common electrodes and the even column pixel electrodes cooperate to form even column pixels; in addition, grayscale signals having different polarities are generated in a drive circuit to respectively connect to the odd column pixels and even column pixels, and divided into a plurality of pixels having different polarities, where the polarities of the first common electrode signals are opposite to the polarities of the grayscale signals of the odd column pixels, the polarities of the second common electrode signals are opposite to the polarities of the grayscale signals of the even column pixels, and the first common electrodes and the second common electrode signals have different polarities, which may enlarge voltage difference between the common electrode signals and the grayscale signals, reduce load of the common electrodes, and thereby decrease power consumption of the display panel.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts.

In the accompanying drawings:

FIG. 1 is a schematic diagram of architecture of a display panel;

FIG. 2 is a constant drive voltage waveform diagram of Vcom;

FIG. 3 is a schematic diagram of architecture of a display panel according to an embodiment of the present application;

FIG. 4 is a schematic partial enlarged perspective diagram of A portion of a display panel according to an embodiment of the present application;

FIG. 5 is a drive voltage waveform diagram of an adjustable voltage according to an embodiment of the present application; and

FIG. 6 is a schematic diagram of a display device according to an embodiment of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying relative importance, or implicitly indicating the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or coupled; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

The present invention will be further described in detail below in conjunction with the accompanying drawings and embodiments.

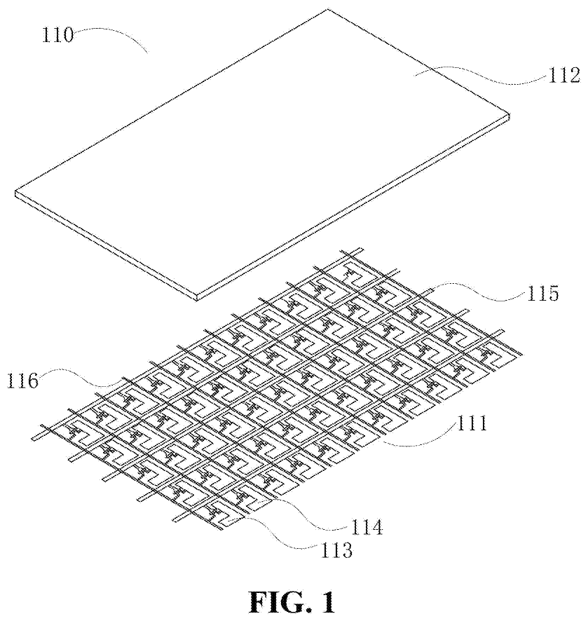

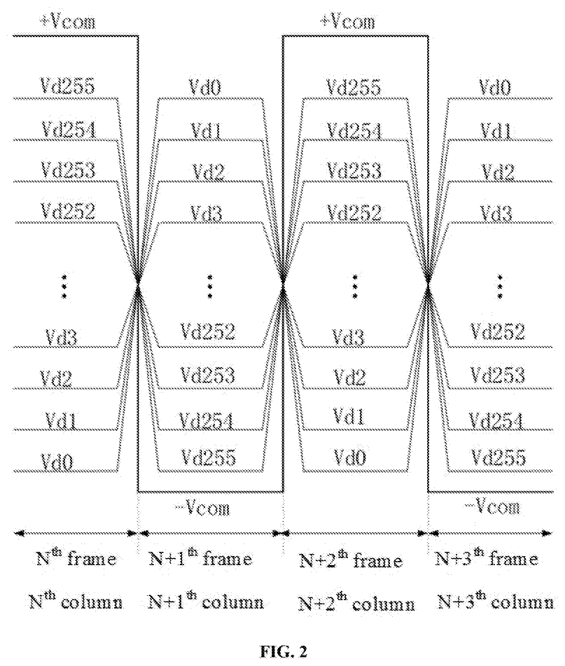

As shown, FIG. 1 is a schematic diagram of main architecture of a thin film transistor-liquid crystal display (TFT-LCD), which includes common electrodes, pixel electrodes, and liquid crystal disposed therebetween. Where, the common electrode is a one-piece indium thin oxide (ITO). When the TFT-LCD is working, a constant Vcom is given to the common electrode as a reference voltage for positive and negative polarities; corresponding grayscale voltages Vd are input to different pixel electrodes through a source line; voltage difference formed between the Vcom and different Vd is different, and the liquid crystal therebetween may be deflected at different angles, which thereby realizes different grayscale display. The constant drive mode voltage waveform of the Vcom is shown in FIG. 2.

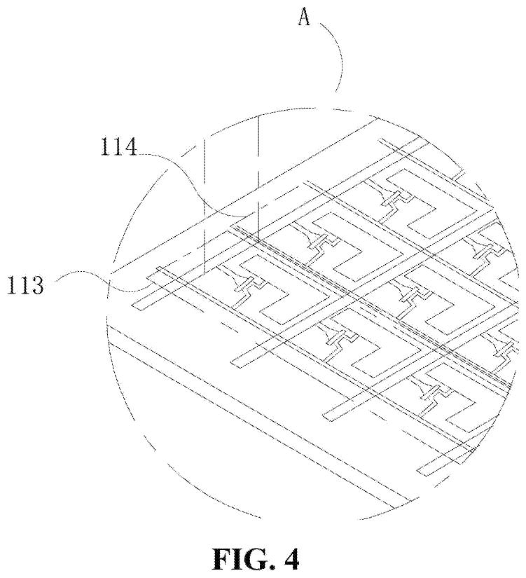

As can be seen from equation, P=(½) fCV\hat{ }2, power consumption P consumed by driving the panel to display images can be reduced by narrowing range of the drive voltage V. And in order to narrow the range of the drive voltage of the liquid crystal panel, the Vcom that is originally constant can be set as adjustable, the drive voltage waveform of which is shown in FIG. 4. When the pixel electrode needs to write a positive voltage therein, the Vcom can be set in a lower value, which is less than all the grayscale voltages, and at this time, all the grayscale voltages range from Vd0 to Vd255; when the pixel electrode needs to write a negative voltage therein, the Vcom can be set in a higher value, which is greater than all the grayscale voltages, and at this time, all the grayscale voltages also range from Vd0 to Vd255. This method narrows the range of the drive voltage V by half by modulating the voltage of the Vcom, and thereby effectively reduces the power consumption consumed by driving the panel.

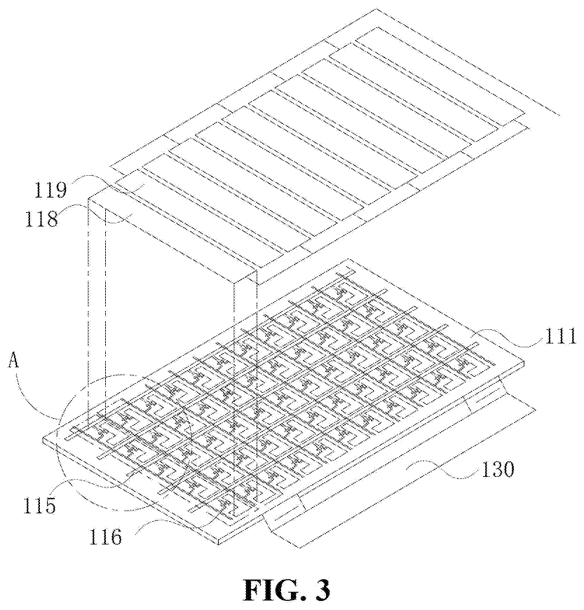

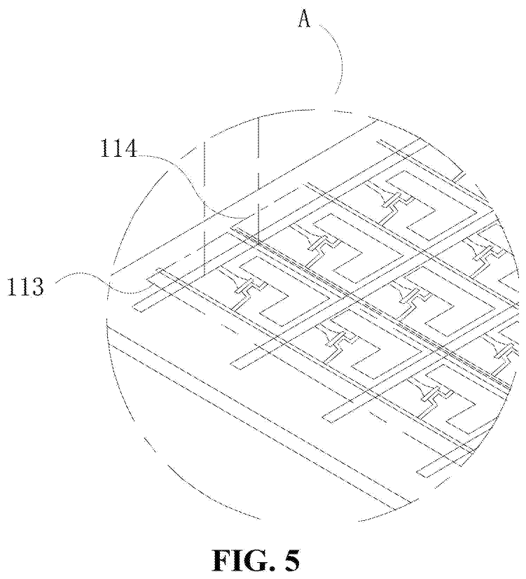

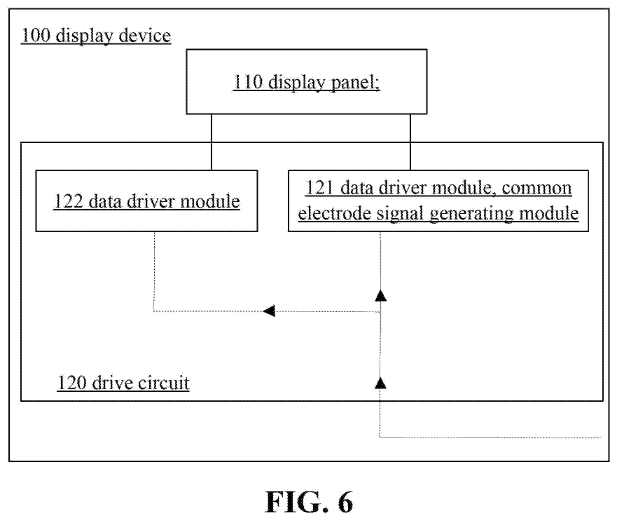

As shown from FIG. 1 to FIG. 6, an embodiment of the present application discloses a display device 100 including a display panel 110 and a drive circuit 120 driving the display panel 110. The display panel 110 includes a plurality of odd column pixel electrodes 113 and a plurality of even column pixel electrodes 114, and first common electrodes 118 and second common electrodes 119, where the first common electrodes 118 and the odd column pixel electrodes 113 cooperate to drive to form odd column pixels, and the second common electrodes 119 and the even column pixel electrodes 114 cooperate to drive to form even column pixels; and where the first common electrodes 118 and the second common electrodes 119 are respectively connected to different electrical signals.

In this solution, the display device 100 includes a display panel 110 including a plurality of a plurality of odd column pixel electrodes 113 and a plurality of even column pixel electrodes 114. The odd column pixel electrodes 113 and the first common electrodes 118 cooperate to form odd column pixels, the second common electrodes 119 and the even column pixel electrodes 114 cooperate to form even column pixels, and the first common electrodes 118 and the second common electrodes 119 are respectively connected to different electrical signals. The polarities of the first common electrode signals are opposite to the polarities of the grayscale signals of the odd column pixels, the polarities of the second common electrode signals are opposite to the polarities of the grayscale signals of the even column pixels, and the first common electrodes 118 and the second common electrode signals have different polarities, which may enlarge voltage difference between the common electrode signals and the grayscale signals, reduce load of the common electrodes, and thereby decrease power consumption of the display device 100.

In one or more embodiments, the display device 100 includes a drive circuit 120 driving the display panel 110. The drive circuit 120 includes: a common electrode signal generating circuit 121 outputting first common electrode signals and second common electrode signals, where the first common electrode signals are transmitted to the first common electrodes 118, and the second common electrode signals are transmitted to the second common electrodes 118; and a data driver chip 122 generating a plurality of grayscale signals, each being respectively connected to one corresponding signal of the odd column pixels and even column pixels, and the data driver chip 122 controls grayscale signals of the odd column pixels and even column pixels to have different polarities; where the first common electrode signals and the second common electrode signals have different polarities; the polarities of the first common electrode signals are opposite to the polarities of the grayscale signals of the odd column pixels; and the polarities of the second common electrode signals are opposite to the polarities of the grayscale signals of the even column pixels.

In this solution, grayscale signals having different polarities are generated in the drive circuit 120 to respectively connect to the odd column pixels and even column pixels, and divided into a plurality of pixels with different polarities, where the polarities of the first common electrode signals are opposite to the polarities of the grayscale signals of the odd column pixels, the polarities of the second common electrode signals are opposite to the polarities of the grayscale signals of the even column pixels, and the first common electrodes 118 and the second common electrode signals have different polarities, which may enlarge the voltage difference between the common electrode signals and the grayscale signals, reduce load of the common electrodes, and thereby decrease power consumption of the display panel.

In one or more embodiments, the grayscale signals of the pixel electrodes perform polarity inversion in units of frames, and the first common electrode signals and the second common electrode signals perform polarity inversion corresponding to the grayscale signals of the pixel electrodes.

In this solution, when the grayscale signals of the pixel electrodes perform polarity inversion, the first common electrode signals and second common electrode signals corresponding to grayscale signals of the pixel electrodes also perform polarity inversion, and the inversion is also performed in units of frames, which prevents the capacitor between the grayscale signals and the common electrode signals from being increased or decreased due to the changes thereof, and thereby enables the display device 100 to display inconsistency situations and meanwhile reduces the power consumption of the common electrodes.

In one or more embodiments, the display panel 110 further includes a first common line 115 and a second common line 116, where the first common line 115 is electrically connected to the first common electrodes 118, and the second common line 116 is electrically connected to the second common electrodes 119; the first common electrodes 118 and the current odd column pixel electrodes 113 form a pixel capacitor of the current odd column pixels; and the first common line 115 and the current odd column pixel electrodes 113 form a storage capacitor of the current odd column pixel electrodes; accordingly, the second common electrodes 119 and the current even column pixel electrodes 114 form a pixel capacitor of the current even column pixels; and the second common line 116 and the current even column pixel electrodes 114 form a storage capacitor of the current even column pixel electrodes 114.

In this solution, the display panel 110 further includes common lines. The first common line 115 and the second common line 116 form a storage capacitor for each pixel; the first common line 115 is electrically connected to the first common electrodes 118, and the second common line 116 is electrically connected to the second common electrodes 119, which can better display the image.

In one or more embodiments, during a same frame of time: the data driver chip 122 controls the grayscale signals of pixels in a same column to have a same polarity; the first common electrode signals have a same polarity; the second common electrode signals have a same polarity; and during a next frame of time, the grayscale signals, the first common electrode signals, and the second common electrode signals perform polarity inversion.

In this solution, during a same frame of time: the data driver chip 122 controls the grayscale signals of pixels in a same column to have a same polarity; the first common electrode signals have a same polarity; the second common electrode signals have a same polarity; and during a next frame of time, the grayscale signals, the first common electrode signals, and the second common electrode signals perform polarity inversion, and this drive mode belongs to column inversion that can better drive the panel.

In one or more embodiments, during a frame of time when a row of scanning lines is turned on: the data driver chip 122 controls grayscale signals of pixels in a same column to have a same polarity; the first common electrode signals have a same polarity; the second common electrode signals have a same polarity; and during the time when a row of scanning lines is turned on, the grayscale signals, the first common electrode signals, and the second common electrode signals perform polarity inversion.

In this solution, the data driver chip 122 controls the grayscale signals of pixels in a same column to have a same polarity; the first common electrode signals have a same polarity; the second common electrode signals have a same polarity; and during the time when a row of scanning lines is turned on, the grayscale signals, the first common electrode signals, and the second common electrode signals perform polarity inversion, and this drive mode belongs to point inversion and can better drive the panel.

In one or more embodiments, the display panel includes a first substrate 111 and a second substrate 112 that are disposed opposite to each other. The plurality of odd column pixels and the plurality of even column pixels are all disposed on the first substrate, and the first common electrodes 118 and the second common electrodes 119 are both disposed on the second substrate 112. The first substrate 111 further includes a first common line 115 and a second common line 116, where the first common line 115 is electrically connected to the first common electrodes 118, and the second common line 116 is electrically connected to the second common electrodes 119; the first common electrodes 118 and the current odd column pixel electrodes 113 form a pixel capacitor of the current odd column pixels; and the first common line 115 and the current odd column pixel electrodes 113 form a storage capacitor of the current odd column pixel electrodes; accordingly, the second common electrodes 119 and the current even column pixel electrodes 114 form a pixel capacitor of the current even column pixels; and the second common line 116 and the current even column pixel electrodes 114 form a storage capacitor of the current even column pixel electrodes 114.

It is a display device 100 of a VA (Vertical Alignment) type architecture. The first common electrodes 118 and the odd column pixel electrodes 113 are disposed opposite to each other to form odd column pixels, and the second common line 116 and the current even column pixel electrodes 114 form a storage capacitor of the current even column pixel electrodes 114. The second common electrodes 119 and the even column pixel electrodes 114 are disposed opposite to each other to form even column pixels, and the second common line 116 and the current even column pixel electrodes 114 form a storage capacitor of the current even column pixel electrodes 114. Such architecture can well display the panel and reduce power consumption of the display device 100.

As shown in FIG. 1 and FIG. 3 to FIG. 6, another embodiment of the present application discloses a display device 100. The display device 100 includes a display panel 110, and a drive circuit 120 driving the display panel 110. The display panel 110 includes a first substrate 111 and a second substrate 112 that are disposed opposite to each other. The first substrate 111 includes a plurality of odd column pixels and a plurality of even column pixels; and the second substrate 112 includes first common electrodes 118 and second common electrodes 119, where the first common electrodes 118 are disposed opposite to the odd column pixels on the first substrate 111, and the second common electrodes 119 are disposed opposite to the even column pixels on the first substrate 111. The drive circuit 120 includes: a common electrode signal generating circuit 121 outputting first common electrode signals and second common electrode signals, where the first common electrode signals are output to the first common electrodes 118 on the second substrate 112, and the second common electrode signals are output to the second common electrodes 119 on the second substrate 112; and a data driver chip 122 generating a plurality of grayscale signals, each being respectively connected to one corresponding signal of the odd column pixels and even column pixels on the first substrate 111. The data driver chip 122 controls grayscale signals of the odd column pixels and even column pixels on the first substrate 111 to have different polarities; where the first common electrode signals and the second common electrode signals have different polarities; the polarities of the first common electrode signals are opposite to the polarities of the grayscale signals of the odd column pixels; and the polarities of the second common electrode signals are opposite to the polarities of the grayscale signals of the even column pixel. The first common electrodes 118 and the second common electrodes 119 are a plurality of blocks, and a portion is etched away between the first common electrodes 118 and the second common electrodes 119 to reduce load of the first common electrodes 118 and the second common electrodes 119. And the data driver chip 122 and common electrode signal generating circuit 121 of the drive circuit 120 are disposed on a print circuit board (PCB) 130, and the PCB is provided with a power chip that supplies voltage to the common electrodes.

In this solution, the display device 100 includes a display panel 110 including a plurality of odd column pixel electrodes 113 and a plurality of even column pixel electrodes 114, where the odd column pixel electrodes 113 and the first common electrodes 118 cooperate to form odd column pixels, the second common electrodes 119 and the even column pixel electrodes 114 cooperate to form even column pixels, and grayscale signals having different polarities are generated in the drive circuit 120 to respectively connect to the odd column pixels and even column pixels and further divided into a plurality of pixels with different polarities. The polarities of the first common electrode signals are opposite to the polarities of the grayscale signals of the odd column pixels, the polarities of the second common electrode signals are opposite to the polarities of the grayscale signals of the even column pixels, and the first common electrodes 118 and the second common electrode signals have different polarities, which enables the column inversion to be performed on the common electrodes and thereby decrease power consumption of the display device 100.

As shown in FIG. 1 and FIG. 3 to FIG. 6, another embodiment of the present application discloses a display panel 110 including a plurality of odd column pixel electrodes 113 and a plurality of even column pixel electrodes 114, and first common electrodes 118 and second common electrodes 119, where the first common electrodes 118 and the odd column pixel electrodes 113 cooperate to drive to form odd column pixels, and the second common electrodes 119 and the even column pixel electrodes 114 cooperate to drive to form even column pixels; and the first common electrodes 118 and the second common electrodes 119 are respectively connected to different electrical signals.

This solution provides a display panel 110, and the architecture of the display panel 110 includes a plurality of odd column pixel electrodes and a plurality of even column pixel electrodes, where the odd column pixel electrodes 113 and the first common electrodes 118 cooperate to drive to form odd column pixels, the even column pixel electrodes 114 and the second common electrodes 119 cooperate to drive to form even column pixels, and the first common electrodes 118 and the second common electrodes 119 are respectively connected to different electrical signals. Such architecture of the display panel 110 can support polarity inversion of the odd column pixels and even column pixels, which enables the display panel 110 to better display the image.

In one or more embodiments, the display screen 10 further includes a first common line 115 and a second common line 116, where the first common line 115 is electrically connected to the first common electrodes 118, and the second common line 116 is electrically connected to the second common electrodes 119; the first common electrodes 118 and the current odd column pixel electrodes 113 form a pixel capacitor of the current odd column pixels; and the first common line 115 and the current odd column pixel electrodes 113 form a storage capacitor of the current odd column pixel electrodes; accordingly, the second common electrodes 119 and the current even column pixel electrodes 114 form a pixel capacitor of the current even column pixel electrodes; and the second common line 116 and the current even column pixel electrodes 114 form a storage capacitor of the current even column pixel electrodes 114.

In this solution, the architecture of the display panel 110 further includes common lines. The first common line 115 and the second common line 116 form a storage capacitor for each pixel; the first common line 115 is electrically connected to the first common electrodes 118, and the second common line 116 is electrically connected to the second common electrodes 119, which can better display the image.

As shown in FIG. 1 and FIG. 3 to FIG. 6, another embodiment of the present application discloses a display device driving method. The odd column pixels and even column pixels are driven by the voltage having different polarities; the polarities of the first common electrode signals are opposite to the polarities of the grayscale signals of the odd column pixels; and the polarities of the second common electrode signals are opposite to the polarities of the grayscale signals of the even column pixels.

This solution provides a method of driving the display panel 110. The display panel 110 includes a plurality of odd column pixel electrodes 113 and a plurality of even column pixel electrodes 114, and first common electrodes 118 and second common electrodes 119. The first common electrodes 118 and the odd column pixel electrodes 113 cooperate to form odd column pixels, and the second common electrodes 119 and the even column pixel electrodes 114 cooperate to form even column pixels; the first common electrode signals and the second common electrode signals are driven by voltages having different polarities; the odd column pixels and even column pixels are driven by the voltage having different polarities; the polarities of the first common electrode signals are opposite to the polarities of the grayscale signals of the odd column pixels; and the polarities of the second common electrode signals are opposite to the polarities of the grayscale signals of the even column pixels. Under this method of driving the display panel 110, the load of the common electrode signal generating circuit 121 can be reduced and the image can be better displayed.

In one or more embodiments, during a same frame of time: the data driver chip 122 controls the grayscale signals of pixels in a same column to have a same polarity; the first common electrode signals have a same polarity; the second common electrode signals have a same polarity; and during a next frame of time, the grayscale signals, the first common electrode signals, and the second common electrode signals perform polarity inversion.

In this solution, during a same frame of time: the data driver chip 122 controls the grayscale signals of pixels in a same column to have a same polarity; the first common electrode signals have a same polarity; the second common electrode signals have a same polarity; and during a next frame of time, the grayscale signals, the first common electrode signals, and the second common electrode signals perform polarity inversion, and this drive method belongs to column inversion that can better drive the panel.

The present application is also applicable to an IPS (In-Pane Switching) panel, and the odd column pixel electrodes, the even column pixel electrodes, the first common electrodes, and the second common electrodes are all disposed at a same position as the VA substrate.

The foregoing is an optional detailed description of the present application with reference to specific optional embodiments, and it should not be considered that the specific implementation of the present application is not limited to the description. A person of ordinary skill in the art of the present application may further make several simple deductions or substitutions without departing from the concept of the present application, and the deductions or substitutions shall fall within the protection scope of the present application.

What is claimed is:

1. A display device, comprising:
a display panel;
the display panel, comprising:
a plurality of odd column pixel electrodes and a plurality of even column pixel electrodes; and
first common electrodes and second common electrodes;
wherein the first common electrodes and the odd column pixel electrodes cooperate to drive to form odd column pixels; and the second common electrodes and the even column pixel electrodes cooperate to drive to form even column pixels; and
the first common electrodes and the second common electrodes are respectively connected to different electrical signals.

2. The display device according to claim 1, wherein the display device comprises a drive circuit driving the display panel, and the drive circuit comprises:
a common electrode signal generating circuit outputting first common electrode signals and second common electrode signals, the first common electrode signals being transmitted to the first common electrodes, and the second common electrode signals being transmitted to the second common electrodes; and
a data driver chip generating a plurality of grayscale signals, each being respectively connected to one corresponding signal of the odd column pixels and even column pixels, the data driver chip controlling the grayscale signals of the odd column pixels and even column pixels to have different polarities;
wherein the first common electrode signals and the second common electrode signals have different polarities; the polarities of the first common electrode signals are opposite to the polarities of the grayscale signals of the odd column pixels; and the polarities of the second common electrode signals are opposite to the polarities of the grayscale signals of the even column pixels.

3. The display device according to claim 2, wherein the data driver chip and the common electrode signal generating circuit of the drive circuit are disposed on a print circuit board.

4. The display device according to claim 3, wherein the print circuit board is provided with a power chip supplying voltage to the common electrodes.

5. The display device according to claim 2, wherein the grayscale signals of the pixel electrodes perform polarity inversion in units of frames, and the first common electrode signals and the second common electrode signals perform polarity inversion corresponding to grayscale signals of the pixel electrodes.

6. The display device according to claim 1, wherein the display panel further comprises a first common line and a second common line, wherein the first common line is electrically connected to the first common electrodes, and the second common line is electrically connected to the second common electrodes; the first common electrodes and the current odd column pixel electrodes form a pixel capacitor of the current odd column pixels; and the first common line and the current odd column pixel electrodes form a storage capacitor of the current odd column pixel electrodes; and
accordingly, the second common electrodes and the current even column pixel electrodes form a pixel capacitor of the current even column pixels; and the second common line and the current even column pixel electrodes form a storage capacitor of the current even column pixel electrodes.

7. The display device according to claim 2, wherein during a same frame of time:
the data driver chip controls the grayscale signals of pixels in a same column to have a same polarity;
the first common electrode signals have a same polarity;
the second common electrode signals have a same polarity; and
during a next frame of time, the grayscale signals, the first common electrode signals, and the second common electrode signals perform polarity inversion.

8. The display device according to claim 6, wherein during a frame of time when a row of scanning lines is turned on:
the data driver chip controls the grayscale signals of pixels in a same column to have a same polarity;
the first common electrode signals have a same polarity;
the second common electrode signals have a same polarity; and
during time when a row of scanning lines is turned on, the grayscale signals, the first common electrode signals and the second common electrode signals perform polarity inversion.

9. The display device according to claim 2, wherein the display panel comprises:
a first substrate and a second substrate that are disposed opposite to each other;
wherein the plurality of odd column pixels and the plurality of even column pixels are all disposed on the first substrate;
the first common electrodes and the second common electrodes are both disposed on the second substrate;
the first substrate further comprises a first common line and a second common line;
the first common line is electrically connected to the first common electrodes, and the second common line is electrically connected to the second common electrodes; the first common electrodes and the current odd column pixel electrodes form a pixel capacitor of the current odd column pixels; and the first common line and the current odd column pixel electrodes form a storage capacitor of the current odd column pixel electrodes; and
accordingly, the second common electrodes and the current even column pixel electrodes form a pixel capacitor of the current even column pixels; and the second common line and the current even column pixel electrodes form a storage capacitor of the current even column pixel electrodes.

10. The display device according to claim 9, wherein the display panel comprises:
common electrodes;
pixel electrodes; and
liquid crystal sandwiched between the first substrate and the second substrate.

11. The display device according to claim 9, wherein the display panel is a display panel of a vertical alignment technical type architecture.

12. The display device according to claim 1, wherein the display panel is a display panel of an in-pane switching architecture; and
the first common electrodes and the second common electrodes are disposed on a same substrate.

13. A display device, comprising:
a display panel; and
a drive voltage driving the display panel;
wherein the display panel comprises a first substrate and a second substrate that are disposed opposite to each other;
the first substrate comprises a plurality of odd column pixels and a plurality of even column pixels; and
the second substrate comprises first common electrodes and second common electrodes, wherein the first common electrodes are disposed opposite to the odd column pixels on the first substrate, and the second common electrodes are disposed opposite to the even column pixels on the first substrate;
wherein the drive voltage comprises:
a common electrode signal generating circuit outputting first common electrode signals and second common electrode signals, the first common electrode signals being output to the first common electrodes on the second substrate, and the second common electrode signals being output to the second common electrodes on the second substrate;
a data driver chip generating a plurality of grayscale signals, each being respectively connected to one corresponding signal of the odd column pixels and even column pixels on the first substrate, where the data driver chip controls grayscale signals of the odd column pixels and even column pixels on the first substrate to have different polarities;
wherein the first common electrode signals and the second common electrode signals have different polarities; the polarities of the first common electrode signals are opposite to the polarities of the grayscale signals of the odd column pixels; and the polarities of the second common electrode signals are opposite to the polarities of the grayscale signals of the even column pixels.

14. A display device driving method for driving a display device, the display device, comprising:
a display panel;
the display panel, comprising:
a plurality of odd column pixel electrodes and a plurality of even column pixel electrodes; and
first common electrodes and second common electrodes;
wherein the first common electrodes and the odd column pixel electrodes cooperate to drive to form odd column pixels; and the second common electrodes and the even column pixel electrodes cooperate to drive to form even column pixels; and
the odd column pixel electrodes and even column pixel electrodes are driven by voltages having different polarities; and
the polarities of the first common electrode signals are opposite to the polarities of the grayscale signals of the odd column pixels; and the polarities of the second common electrode signals are opposite to the polarities of the grayscale signals of the even column pixels.

15. The display device driving method according to claim 14, wherein during a same frame of time:
the data driver chip controls the grayscale signals of pixels in a same column to have a same polarity;
the first common electrode signals have a same polarity;
the second common electrode signals have a same polarity; and
during a next frame of time, the grayscale signals, the first common electrode signals, and the second common electrode signals perform polarity inversion.

16. The display device driving method according to claim 14, wherein the display panel further comprises a first common line and a second common line, wherein the first common line is electrically connected to the first common electrodes, and the second common line is electrically connected to the second common electrodes; the first common electrodes and the current odd column pixel electrodes form a pixel capacitor of the current odd column pixels; and the first common line and the current odd column pixel electrodes form a storage capacitor of the current odd column pixel electrodes; and
accordingly, the second common electrodes and the current even column pixel electrodes form a pixel capacitor of the current even column pixels; and the second common line and the current even column pixel electrodes form a storage capacitor of the current even column pixel electrodes.

17. The display device driving method according to claim 16, wherein during a frame of time when a row of scanning lines is turned on:
the data driver chip controls the grayscale signals of pixels in a same column to have a same polarity;
the first common electrode signals have a same polarity;
the second common electrode signals have a same polarity; and
during the time when a row of scanning lines is turned on, the grayscale signals, the first common electrode signals, and the second common electrode signals perform polarity inversion.
